(19) United States
(12) Patent Application Publication
(10) Pub. No.: US 2022/0248709 A1
(43) Pub. Date: Aug. 11, 2022

(54) Creation of novel protein products from hemp and hemp derivatives

(71) Applicant: david alan heldreth, JR., bellevue, WA (US)

(72) Inventor: david alan heldreth, JR., bellevue, WA (US)

(73) Assignee: david alan heldreth, JR., bellevue, WA (US)

(21) Appl. No.: 17/667,381

(22) Filed: Feb. 8, 2022

Related U.S. Application Data
(60) Provisional application No. 63/207,120, filed on Feb. 8, 2021.

(51) Int. Cl. A23J 1/14; A23J 3/14

(52) U.S. Cl. CPC A23J 1/14; A23J 3/14

(57) ABSTRACT

The invention involves the breeding, seed multiplication, vegetative propagation and cultivation of: Cannabis sativa, Cannabis indica, Cannabis ruderalis, feral Cannabis, as well as all hybrids thereof to increase protein content, especially relating to portions of the plant aside from the seed. Further relating to processing, extraction, isolation of proteins from: Cannabis sativa, Cannabis indica, Cannabis ruderalis, feral Cannabis, as well as all hybrids thereof and especially relating to portions of the plant aside from the seed; and the use of these protein rich plant(s), plant part(s), extract(s), isolate(s), cosmetic(s), product(s) etc for medicines, foods, supplements, drinks for animals or humans as well as for use in plant, bacteria, fungi, lichen, algae cultivation.

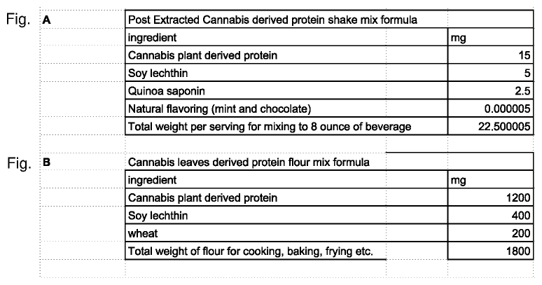

### FIELD OF THE INVENTION

The present invention is directed to the breeding, seed multiplication, vegetative propagation and cultivation of: Cannabis sativa, Cannabis indica, Cannabis ruderalis, feral Cannabis, as well as all hybrids thereof to increase protein content, especially relating to portions of the plant aside from the seed. Further relating to processing, extraction, isolation of proteins from: Cannabis sativa, Cannabis indica, Cannabis ruderalis, feral Cannabis, as well as all hybrids thereof and especially relating to portions of the plant aside from the seed; and the use of these protein rich plant(s), plant part(s), extract(s), isolate(s), cosmetic(s), product(s) etc for medicines, foods, supplements, drinks for animals or humans as well as for use in plant, bacteria, fungi, lichen, algae cultivation.

### BACKGROUND OF THE INVENTION

Cannabis species have increased in cultivation and use across the globe during recent years and in that time we have seen increased demand for goods developed from hemp. There is a high demand for essential oils, plant parts for human and animal foods, protein isolates and other products.

Although the market has focused on increased cannabinoid content primarily, the Cannabis plant is known for its protein content. However, currently only the hemp seed has been utilized for human or animal food. There is no known FDA GRAS or animal products approved.

As such developing protein products from other parts of the Cannabis plant such as the roots, stalk, flower, leaf, post extracted Cannabis leaf/flower/stalk/roots/plant biomass as well as breeding for Cannabis varieties which have higher levels of protein in these plant parts would be valuable for human health as well as profitability of food, agricultural and other industries.

Currently, post extracted Cannabis leaf/flower/stalk/roots/plant biomass is either turned into compost or is typically disposed of due to lack of uses. However, my internal testing has shown up to 10% protein levels in various parts of the Cannabis plant excluding seeds, but including post extracted material. As such these unused portions of the plant could become a valuable feedstock for humans, animals, plants, fungi, industry and beyond.

### SUMMARY OF THE INVENTION

The present invention is directed to the breeding, seed multiplication, vegetative propagation and cultivation of: Cannabis sativa, Cannabis indica, Cannabis ruderalis, feral Cannabis, as well as all hybrids thereof to increase protein content, especially relating to portions of the plant aside from the seed. Further relating to processing, extraction, isolation of proteins from: Cannabis sativa, Cannabis indica, Cannabis ruderalis, feral Cannabis, as well as all hybrids thereof and especially relating to portions of the plant aside from the seed; and the use of these protein rich plant(s), plant part(s), extract(s), isolate(s), cosmetic(s), product(s) etc for medicines, foods, supplements, drinks for animals or humans as well as for use in plant, bacteria, fungi, lichen, algae cultivation.

### BRIEF DESCRIPTION OF THE DRAWINGS

PAGE 1 drawings show potential formulations of Cannabis derived protein products which would be formulated from the protein rich Cannabis plants. PAGE 1 FIG. A shows a recipe for a Cannabis protein beverage which is formulated utilizing post cannabinoid extracted Cannabis plant material derived protein being formulated into a protein shake beverage. Page 1 FIG. B shows a Cannabis protein enriched flour for baking, frying and cooking, which includes Cannabis leaf and/or flower derived protein along with soy lecithin and wheat.

### DRAWING SUMMARY

PAGE 1 drawings show potential formulations of Cannabis derived protein products which would be formulated from the protein rich Cannabis plants. PAGE 1 FIG. A shows a recipe for a Cannabis protein beverage which is formulated utilizing post cannabinoid extracted Cannabis plant material derived protein being formulated into a protein shake beverage. Page 1 FIG. B shows a Cannabis protein enriched flour for baking, frying and cooking, which includes Cannabis leaf and/or flower derived protein along with soy lecithin and wheat.

### DETAILED DESCRIPTION OF THE INVENTION

In some embodiments the Cannabis derived protein products can be mixed with water, oil or other solutions. Some embodiments will include utilizing nano technology, encapsulation, beta glucan particles, chitosan, yeast extract, surfactants, binders and other compounds to increase efficiency, availability, release lifespan, release speed among other parameters.

In some embodiments Cannabis derived protein and products etc are used in foods, drinks, alcoholic beverages, food additives, medicines, supplements, eye drops, nasal spray, mouth spray, rectal, or other uses. Some embodiments are for human use and some are for animal uses.

Some embodiments are used to develop vaccines or treatments for virus, fungi or bacteria illness such as, but not limited to: Coronavirus (such as SARS, COVID-19, MERS), HIV, herpes, syphilis, flu virus, swine flu, avian flu, other virus, bacteria or fungi: antibodies-cytokins-proteins-amino acids-DNA-RNA—DNA/RNA to produce antibodies/proteins/amino acids/RNA/DNA; such as for the spike or other proteins used in vaccines or treatment of virus, fungi or bacteria illness.

### Example 1

An embodiment of the invention involves the cultivation of the protein enriched Cannabis plants. Then isolation of protein from post cannabinoid and/or terpene or other biochemical extracted Cannabis biomass of said Cannabis plants which is then mixed with soy lecithin, quinoa saponins and natural flavoring to create a protein powder in a 3:1:0.5:0.000001 ratio. This mixture is then directed to be added to 8 ounces of water and stirred until blended for drinking.

### Example 2

An embodiment of the invention involves the cultivation of the protein enriched Cannabis plants. Then isolation of protein from the leaves of said Cannabis plants which is then mixed with soy lecithin and wheat in a 1:2:6 ratio to create a protein based flour for cooking, frying, banking and related processes.

1. A method of creating a Cannabis derived protein product via cultivation of protein rich cultivars of Cannabis species of plant(s), wherein protein rich cultivar is defined as containing plant parts with either above: 5%, 10%, 15%, 20%, 25%, 30%, 35%, 40% of protein; in the plant(s) part(s) tested.

2. A method of claim 1 in which the Cannabis derived protein product is a plant part such as, but not limited to: leaf, leaves, stalk(s), root(s), flower(s), seed(s),

3. A method of claim 2 in which the leaves or flowers are used for consumption raw, dried, frozen, freeze dried or similarly processed.

4. A method of claim 1 in which the product is further submitted to further processing, extraction, isolation or related methods.

5. A method of claim 1 in which the Cannabis derived protein product is a protein or protein extract.

6. A method of claim 1 in which the Cannabis derived protein product is added to: cannabinoids, endocannabinoids, terpenes, terpenoids, phytochemicals, Cannabis extracts, Cannabis plant matter, 5ht2 ligands, 5ht ligands, cb1 or cb2 ligands, psychedelics, botanical extracts, fungi extracts, or additionally “wheat or other flours for cooking, frying, baking etc”.

7. A method of claim 1 in which the Cannabis derived protein product is delivered using items such as, but not limited to: chitosan, surfactants, binders, emulsifiers, 3-dimensional printing, atomic printing, nano or other encapsulation techniques such as, but not limited to: yeast cells, beta glucan particles/shells.

8. A method of claim 1 in which the Cannabis derived protein product is used in items such as, but not limited to: foods, supplements, beverages, tea bags, teas, protein bars, protein shakes, protein pills, protein powders, protein flours, coffees, coffee brewing mixes and packages, pre packaged food, food additives, sprays, eye drops, nasal drops/sprays, mouth spray, capsules, sublingual delivery, sublingual tabs, gel tabs, all oral methods, inhalation methods, topical methods, alcoholic beverages, topicals, lotions, cosmetics, perfumes, tobacco products, psychedelic products, Cannabis products, medicines, inhalers, tinctures, vaporizers, smoking blends, vaping blends, smoking items such, but not limited to: cigars/cigarettes/joints/pre-rolls/hookah.

9. A method of claim 1 in which the Cannabis derived protein products are provided in a premixed composition in a container, reservoir or other receptacle, for use at a rate between: 0.00000000000000000000000001%-100% of active compound per volume, weight or mass, but which may be concentrated up to 100% purity. Reservoir, container or other receptacle may additionally include additives, surfactants, emulsifiers or other items to increase bioavailability, stability, viscosity, absorption/activation timeframe.
